(19) United States
(12) Patent Application Publication
(10) Pub. No.: US 2024/0272064 A1
(43) Pub. Date: Aug. 15, 2024

(54) SAMPLE AND EVALUATION METHOD FOR MEASURING GALVANIC CORROSION BETWEEN CONDUCTIVE COATING AND PROTECTED SUBSTRATE

(71) Applicant: WUHAN RESEARCH INSTITUTE OF MATERIALS PROTECTION, Wuhan (CN)

(72) Inventors: Dongdong LI, Wuhan (CN); Lanxuan LIU, Wuhan (CN); Yang WANG, Wuhan (CN); Xiusheng LIU, Wuhan (CN); Weihua QIN, Wuhan (CN); Zenghui FENG, Wuhan (CN); Dongheng WU, Wuhan (CN); Bei GUO, Wuhan (CN); Junjie SHU, Wuhan (CN)

(73) Assignee: WUHAN RESEARCH INSTITUTE OF MATERIALS PROTECTION, Wuhan (CN)

(21) Appl. No.: 17/793,045

(22) PCT Filed: Nov. 22, 2021
(86) PCT No.: PCT/CN2021/131983

§ 371 Date: Jul. 15, 2022

(51) Int. Cl. G01N 17/02; G01N 17/00

(52) U.S. Cl. CPC G01N 17/02; G01N 17/006

(57) ABSTRACT

The present disclosure relates to a sample and an evaluation method for measuring galvanic corrosion between a conductive coating and a protected substrate. A micropore insulating layer is arranged between the conductive coating and the substrate, the micropore insulating layer is composed of an insulating material and contains a micropore structure, the micropore structure can form an ion pathway on the surfaces of the conductive coating and the substrate after being filled with a conductive medium, and the substrate and the conductive coating are both connected with an independent leading wire. The sample of the present disclosure can evaluate galvanic corrosion between a conductive coating and other conductive materials more fully.

### CROSS REFERENCE TO RELATED APPLICATIONS

The present disclosure claims the priority from Chinese patent application No. “202110220381.4”, titled “Sample and Evaluation method for Measuring Galvanic Corrosion between Conductive Coating and Protected Substrate”, filed on Feb. 26, 2021 to China National Intellectual Property Administration, which is hereby incorporated herein by reference in its entirety.

### TECHNICAL FIELD

The present disclosure belongs to the technical field of material surface engineering, and particularly relates to a sample and an evaluation method for measuring galvanic corrosion between a conductive coating and other conductive materials.

### BACKGROUND

A conductive coating is a functional material widely used in the fields such as electric conduction, electromagnetic shielding and anti-static electricity. According to the paint composition, and the conductive mechanism, conductive paint can be divided into intrinsic conductive paint, doped conductive paint and composite conductive paint: the film forming matter of the intrinsic conductive paint is the conductive material thereof, such as polyaniline, polypyrrole and polythiophene, and molecules of such, material contain conjugated π bond structures, which can be significantly improved in the electric conductivity by electrochemical or chemical “doping” means; the conductive material of the doped conductive paint is a conductive filler and realizes the conducting function by adding the conductive filler to the film forming matter, and frequently-used conductive fillers mainly include pure metal powder (silver, copper, nickel, etc.), metal coated powder (coated metal such as silver and copper or nonmetal), carbon conductive fillers (graphene, carbon nanotube, graphite, carbon fiber, carbon black, etc.) and metal oxides (tin oxide, zinc oxide, tellurium dioxide, etc.); and for the composite conductive paint, a conductive filler is added to the conductive film forming matter, and the film forming matter and the conductive filler are both used as conductive materials,

Conductive paint is directly applied to the surface of a substrate. When a corrosive medium penetrates the coating and reaches the substrate, potential difference between the conductive coating and the substrate easily causes galvanic corrosion, which results in corrosion of the substrate or the filler and thus leads to phenomena of coating bulge and shedding. Therefore, it is necessary to establish a method for evaluating galvanic corrosion between a conductive coating and a metal substrate, which is used for laboratory measurement of the galvanic corrosion trend, the start time of galvanic corrosion and the galvanic corrosion rate between conductive paint and a metal substrate and for evaluation of the corrosion resistance of the conductive coating.

At present, galvanic corrosion evaluation methods mainly include GB/T 15748-2013 The method of galvanic corrosion test for metallic ship materials and HP 5374-87 Test Method for Different Metal Galvanic Current, which are used for evaluation of galvanic corrosion between different metals (metals and alloys, metal platings and coatings, and metal surface inorganic membranes) and between metals and carbon fiber-epoxy composite metals. The evaluation of galvanic corrosion between conductive paint and a metal substrate mainly has the following problems:

(1) Galvanic corrosion between a conductive coating and other conductive materials is not involved;

(2) After a test circuit is energized, galvanic corrosion begins, and the time of galvanic corrosion caused by the penetration of a corrosive medium through the coating surface into the substrate cannot be measured, i.e., the process from protecting the substrate by the conductive coating to protection failure to cause galvanic corrosion cannot be effectively evaluated:

(3) Main evaluation indexes are the galvanic corrosion rate (galvanic current density) and corrosion morphology.

The conductive paint has the functions of electrical conductivity and protection, and the protection capability thereof against substrate corrosion is an important index to evaluate the performance. Therefore, the performance of the conductive paint can be evaluated more reasonably by considering the start time of galvanic corrosion, the galvanic corrosion rate (galvanic current density) and corrosion morphology.

### SUMMARY

The present disclosure provides a sample and an evaluation method for measuring galvanic corrosion between a conductive coating and a substrate. The test part of the sample is composed of a substrate to be tested, a conductive coating to be tested and a micropore insulating layer, wherein the micropore insulating layer is located between the substrate and the conductive coating and can form an ion pathway on the surfaces of the conductive coating and the substrate after being filled with a conductive medium, and the substrate and the conductive coating are both connected with an independent leading wire.

In some embodiments, the substrate is selected from substrates that easily produce or are capable of producing electrochemical corrosion when in contact with the conductive material and in, an electrolyte together with the conductive material; and/or

The substrate is selected from substrates that cause the conductive material to easily produce or be capable of producing electrochemical corrosion when in contact with the conductive material and in an electrolyte together with the conductive material; and/or

The substrate is selected from substrates that easily produce or are capable of producing current between the substrates and the conductive material when in contact with the conductive material and in an electrolyte together with the conductive material; and/or

The substrate is selected from substrates that are easily corroded in an electrolyte; and/or

The substrate is selected from substrates with electrical conductivity.

In some embodiments, the substrate comprises a material body or a material coating; and the material body or the material coating is selected from but not limited to: a conductor, a semiconductor and a conductive material.

In some embodiments, the conductor includes: a metal, graphite and a carbon conductor material.

In some embodiments, the semiconductor includes: a silicon-containing material, a germanium-containing material, a gallium-containing material, a selenium-containing material, a manganese oxide, a chromium oxide, an iron oxide and a copper oxide.

In some embodiments, the substrate includes a metal, a metal plating/coating, a conductive coating and a carbon fiber material.

In some embodiments, the surface of the sample except the test part is coated with an insulating protective layer.

In some embodiments, the resistivity between the substrate and the micropore insulating layer is more than 1×10¹¹Ω·m; and the resistivity between the conductive coating and the micropore insulating layer is more than 1×10¹¹Ω·m.

In some embodiments, after the micropore structure of the micropore insulating layer is filled with a conductive medium, the difference between the resistivity of the micropore insulating layer and the resistivity of the conductive medium itself is not more than 5%.

In some embodiments, the pore structure of the micropore structure makes the time required for the corrosive medium, to conduct from one side of the micropore insulating layer to the other side not more than 180 s.

In some embodiments, the thickness of the micropore insulating layer is not more than 20 μm.

In some embodiments, the micropore insulating layer is a porous ceramic coating.

The present disclosure provides an electrochemical device for measuring galvanic corrosion between a conductive coating and a substrate, which comprises a sample for measuring galvanic corrosion between a conductive coating and a substrate as described in any of the above paragraphs.

The present disclosure provides applications of the sample for measuring galvanic corrosion between a conductive coating and a substrate as described in any of the above paragraphs in evaluating galvanic corrosion of a conductive coating.

The present disclosure provides applications of the electrochemical device for measuring galvanic corrosion between a conductive coating and a substrate in, evaluating galvanic corrosion of a conductive coating.

The present disclosure provides an evaluation method for galvanic corrosion of a conductive coating, which adopts the sample as described in any of the above paragraphs for galvanic corrosion tests.

In some embodiments, the evaluation method comprises the following steps:

(1) Obtaining a sample composed of a conductive coating to be tested, a micropore insulating layer and a substrate;

(2) Obtaining a corrosive medium to be tested;

(3) Immersing the test part of the sample into the corrosive medium, and preventing the substrate from being in contact with the corrosive medium;

(4) Selecting a reference electrode as required, connecting a circuit and measuring instruments, and measuring galvanic current by a zero resistance current method.

In some embodiments, the evaluation method also comprises a step of considering the total time from measuring the, galvanic current to measuring the occurrence of the galvanic corrosion as an indicator for evaluating the galvanic corrosion.

### DESCRIPTION OF DRAWINGS

FIG. 1 is a structural schematic diagram of a sample for measuring galvanic corrosion between a conductive coating and a substrate of the present disclosure;

FIG. 2 is a diagram of a device for evaluation experiments of galvanic corrosion of a conductive coating of the present disclosure.

FIG. 3 is a diagram of a device for an experimental process of galvanic corrosion of a conductive coating in some embodiments of the present disclosure, wherein arrows indicate moving directions of a corrosive medium, and black dots indicate a corrosive medium.

FIG. 4 is a diagram of a device for an experimental process of galvanic corrosion of a conductive coating in some embodiments of the present disclosure, wherein arrows indicate moving directions of a corrosive medium, and black dots indicate a corrosive medium.

### REFERENCE SIGNS IN THE FIGURES

1, substrate; 2, micropore insulating layer; 3, conductive coating; 4, closed insulating layer; 5, leading wire; 6, sample; 7, reference electrode; and 8, corrosive medium.

### DETAILED DESCRIPTION

In view of the evaluation of galvanic corrosion between a conductive coating and other conductive materials, the present disclosure provides a sample and an evaluation method capable of evaluating galvanic corrosion between a conductive coating and other conductive materials more fully.

One embodiment of the present disclosure provides a sample for measuring galvanic corrosion between a conductive coating and a substrate. The test part of the sample is composed of a substrate to be tested, a conductive coating to be tested and a micropore insulating layer, wherein the micropore insulating layer is located between the substrate to be tested and the conductive coating to be tested and composed of an insulating material, the micropore insulating layer contains a micropore structure and can form an ion, pathway on the surfaces of the conductive coating and the substrate after being filled with a conductive medium, and the substrate and the conductive coating are both connected with an independent leading wire. Corrosive medium is also called conductive medium herein.

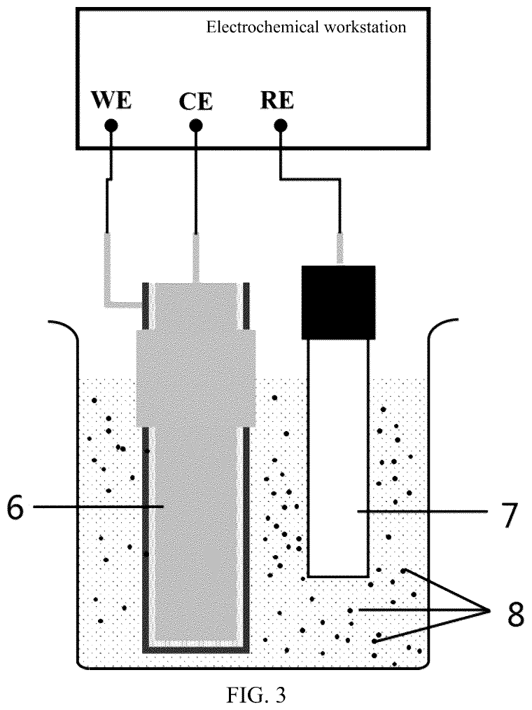

With reference to FIG. 3, the insulating material provided by the present disclosure is located between the substrate and the conductive coating and plays a good insulating role between the substrate and the conductive coating before the corrosive medium penetrates the conductive coating; and effective measurement of galvanic corrosion between the substrate and the conductive material in an electrolyte (such as water or seawater present under natural conditions) can be realized so as to avoid direct contact between the substrate and the conductive material to make it impossible to measure current, causing the process of galvanic corrosion not to be measured.

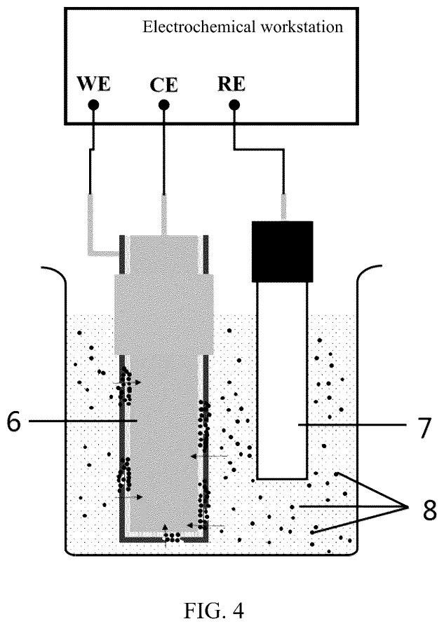

With reference to FIG. 4, micropores in the insulating material can enable the corrosive medium to rapidly reach the substrate through the micropore insulating material after the corrosive medium penetrates the conductive coating, forming an ion pathway. That is to say, the measurement of galvanic corrosion is not affected by filling into the micropore insulating layer, which avoids influence on the measurement of galvanic corrosion due to incapability of or delay in reaching the substrate when the corrosive medium penetrates the conductive layer, for example, measurement cannot be performed, or the measurement error is large. To sum up, the micropore insulating layer of the present disclosure realizes effective measurement of galvanic corrosion between the substrate and the conductive coating in an electrolyte, and the accuracy of measurement of galvanic corrosion is not affected by filling into the micropore insulating layer. In some embodiments, the substrate is selected from substrates that easily produce or are capable of producing electrochemical corrosion when in contact with the conductive material and in an electrolyte (such as water or seawater present under natural conditions) together with the conductive material; and/or

The substrate is selected from substrates that cause the conductive material to easily produce or be capable of producing electrochemical corrosion when in contact with the conductive material and in an electrolyte (such as water or seawater present under natural conditions) with the conductive material; and/or

The substrate is selected from substrates that easily produce or are capable of producing current between the substrates and the conductive material when in contact with the conductive material and in an electrolyte (such as water or seawater present under natural conditions) together with the conductive material; and/or

The substrate is selected from substrates that are easily corroded in an electrolyte; and/or

The substrate is selected from substrates with electrical conductivity.

In some embodiments, the substrate comprises a material body or a material coating.

In some embodiments, the material body or the material coating is selected from but not limited to: a conductor, a semiconductor and a conductive material.

In some alternative embodiments, the conductor includes but is not limited to: a metal and a carbon conductor material.

In some alternative embodiments, the semiconductor includes but is not limited to: a silicon-containing material, a germanium-containing material, a gallium-containing material, a selenium-containing material, a manganese oxide, a chromium oxide, an iron oxide and a copper oxide.

In some alternative embodiments, the conductive material in the material coating includes but is not limited to polyaniline, polypyrrole, polythiophene, metal oxides (such as tin oxide, zinc oxide and tellurium dioxide), metal coated powder (coated metal such as silver and copper or nonmetal) and carbon conductive fillers (such as graphene, carbon nanotube, graphite, carbon fiber and carbon black).

In some embodiments, the substrate includes a metal, a metal plating/coating, a conductive coating and a carbon fiber material. In some embodiments, the surface of the sample except, the test part is coated with an insulating protective layer. The insulating protective layer can protect the substrate, prevent a conducting wire connected with a sample from being in contact with the corrosive medium during measurement, and prevent the interface between air and the corrosive medium from producing additional corrosion to the conductive coating so as to eliminate errors in the experimental process. The insulating protective layer can resist corrosion, of the corrosive medium, isolate the conducting wire for test from the corrosive medium during measurement, and avoid additional corrosion produced by the interface during the experimental test process. In some embodiments, the insulating protective layer is wax.

In some embodiments, the resistivity between the substrate and the micropore insulating layer is more than 1×10¹¹ Ω·m−5×10¹¹ Ω·m, ; and the resistivity between the conductive coating and the micropore insulating layer is more than 1×10¹¹ Ω·m. That is to say, the resistivity between the substrate and the microporous insulating layer only needs to meet insulation between the substrate and the conductive coating and will not form an electronic pathway.

In some embodiments, the resistivity between the substrate and the micropore insulating layer is 1×10¹¹ Ω·m-5×10¹¹ Ω·m, 1×10¹¹ Ω·m−1×10¹² Ω·m or 5×10¹¹ Ω·m−1×10¹² Ω·m, for example, more than or equal to 1×10¹¹ Ω·m, more than or equal to 4×10¹¹ Ω·m, more than or equal to 6×10¹¹ Ω·m, more than or equal to 8×10¹¹ Ω·m or more than or equal to 1×10¹² Ω·m. In some embodiments, the resistivity between the conductive coating and the micropore insulating layer is 1×10¹¹ Ω·m-5×10¹¹ Ω·m, 1×10¹¹ Ω·m-1×10¹² Ω·m or 5×10¹¹ Ω·m−1×10¹² Ω·m, for example, more than or or equal to 1×10¹¹ Ω·m, more than or equal to 3×10¹¹ Ω·m, more than or equal to 5×10¹¹ Ω·m, more than or equal to 7×10¹¹ Ω·m, more than or equal to 9×10¹¹ Ω·m or more than or equal to 1×10¹² Ω·m.

Under the control of the above resistivity, it can be further ensured that before the corrosive medium penetrates the conductive coating, that is, when no corrosive medium enters the substrate, complete insulation between the substrate and the conductive coating can be effectively guaranteed, and meanwhile, the accuracy and wide adaptability of measurement are improved, which can be widely used in the substrate and the conductive coating as described in any of the above paragraphs. In some embodiments, to ensure the accuracy of test results, after the micropore structure of the micropore insulating layer is filled with a conductive medium, the difference between the resistivity of the micropore insulating layer and the resistivity of the conductive medium (corrosive medium) itself is not more than 5%, for example, 1%-5%, 0.1%-4% or 1%-3.5%, such as not more than 4.5%, not more than 4%, not more than 3.5%, not more than 3%, not more than 2.5%, not more than 2%, not more than 1.5%, not more than 1% and not more than 0.5%.

That is to say, after the corrosive medium penetrates the conductive coating, the difference between the resistivity of the corrosive medium penetrating and filling the micropore insulating layer and the resistivity of the corrosive medium itself (i.e., under the natural condition that the corrosive medium does not fill the micropore insulating layer) is less than or equal to 5%, so as to ensure the effectiveness and accuracy (ensure that the accuracy is more than 95%) of measurement of galvanic corrosion and ensure that the resistivity of the corrosive medium (i.e., the above conductive medium) is not affected by filling into the micropore insulating layer. It should be noted that in the present embodiment and example, galvanic corrosion is measured to meet the following standards: when the area ratio of the corrosive medium to the test sample is not less than 20 mL/cm² (GB/T 15748), corrosion products contained, have minimal effect on the solution itself, and the effect is negligible for measuring the resistivity of galvanic corrosion.

When the difference in the resistivity is more than 5%, for example, micropores in the micropore insulating layer are small, so the corrosive medium passes through the micropore insulating layer at a low speed, causing the error of measurement of galvanic corrosion to increase gradually.

In the present disclosure, the conductive medium is the corrosive medium penetrating the micropore structure. In some embodiments, the pore structure of the micropore structure makes the time required for the corrosive medium to conduct from one side of the micropore insulating layer to the other side not more than 180 s. To reduce the error of measurement results, the shorter time is better. Since the test time generally starts from 1 h, 180 s can meet the error requirement. That is to say, the required time is less than or equal to the total time from the beginning of the test until the measured current is not 0 multiplied by percentage error (%), for example, if the total time from the beginning of the test until the measured current is not 0 is 50 min, and the required error rate is 5%, the required time is less than or equal to 150 s.

The above required time will affect the time point when the corrosion current is not 0. Within the range of the above required time, it can be ensured that the corrosive medium can pass through and continuously pass through the micropore insulating layer after penetrating the conductive coating, so as to reduce the delay caused by the corrosive medium passing through the micropore insulating layer and effectively improve the accuracy of measurement of galvanic corrosion.

In some embodiments, the thickness of the micropore insulating layer is not more than 20 μm, for example, 2-20 μm, 5-15 μm or 10-12 μm.

If the thickness of the micropore insulating layer is within the above range, the time for the corrosive medium to pass through the micropore insulating layer can be further controlled to a lower range to ensure that the corrosive medium passes through and continuously passes through the micropore insulating layer, which further effectively improves the accuracy of measurement of galvanic corrosion.

In some embodiments, the micropore insulating layer only needs to meet the following conditions: in the dry state, insulation is realized, and in the wet state, after the micropore structure of the micropore insulating layer is filled with the conductive medium, the difference between the resistivity of the micropore insulating layer filled with the conductive medium (corrosive medium) and the resistivity of the conductive medium (corrosive medium) itself is not more than 5%.

In some embodiments, the micropore insulating layer is a porous ceramic coating or a porous polymer layer. In some embodiments, the micropore insulating layer is a porous ceramic coating. In some embodiments, the porous ceramic coating is selected from zirconia ceramics, alumina ceramics, silicon nitride ceramics, aluminum nitride ceramics, lead borate glass ceramics, tin-barium borate ceramics and beryllia ceramics. The present disclosure also provides an electrochemical device for measuring galvanic corrosion between a conductive coating and a substrate, which comprises the sample for measuring galvanic corrosion between a conductive coating and a substrate.

In some embodiments, the electrochemical device comprises:

A container, containing a corrosive medium;

A sample, wherein the test part of the sample is immersed into the corrosive medium, and the substrate is prevented from being in contact with the corrosive medium; and

A reference electrode, at least one part of which is immersed into the corrosive medium;

A galvanic current measuring device, which is respectively electrically connected with the conductive coating of the sample, the substrate electrically connected with the sample and the reference electrode.

As shown in FIG. 3, the galvanic current measuring device is respectively electrically connected with the conductive coating of the sample, the substrate electrically connected with the sample and the reference electrode so that the conductive coating of the sample is a working electrode (WE) of the galvanic current measuring device, the substrate of the sample is a counter electrode (CE) of the galvanic current measuring device, and the reference electrode is a reference electrode (RE) of the galvanic current measuring device. In, other words, the interface end of the working electrode (WE) of the galvanic current measuring device is electrically connected with the conductive coating of the sample, the interface end of the counter electrode (CE) of the galvanic current measuring device is electrically connected with the substrate of the sample, and the interface end of the reference electrode (RE) of the galvanic current measuring device is electrically connected with the reference electrode. In the electrochemical device, the conductive coating of the sample is used as the working electrode (WE) and the substrate of the sample is used as the counter electrode (CE) so that galvanic current can be measured.

In some embodiments, the galvanic current measuring device is selected from a zero resistance ammeter, a galvanic corrosion measuring instrument, a constant potential rectifier which can be connected with a zero resistance circuit, or an electrochemical workstation.

In some embodiments, the corrosive medium can be selected from seawater, artificial seawater or saline water.

One embodiment of the present disclosure provides an electrochemical device for measuring galvanic corrosion between a conductive coating and a substrate, which comprises a sample for measuring galvanic corrosion between a conductive coating and a substrate.

One embodiment of the present disclosure provides applications of the sample for measuring galvanic corrosion between a conductive coating and a substrate in evaluating galvanic corrosion of a conductive coating.

One embodiment of the present disclosure provides applications of the electrochemical device for measuring galvanic corrosion between a conductive coating and a substrate in evaluating galvanic corrosion of a conductive coating.

One embodiment of the present disclosure provides an evaluation method for galvanic corrosion of a conductive coating, which adopts the above sample for galvanic corrosion tests.

In some embodiments, the evaluation method comprises the following steps:

(1) Obtaining a sample composed of a conductive coating to be tested, a micropore insulating layer and a substrate;

(2) Obtaining a corrosive medium to be tested;

(3) Immersing the test part of the sample into the corrosive medium, and preventing the substrate from being in contact with the corrosive medium;

(4) Selecting a reference electrode as required, connecting a circuit and measuring instruments, and measuring galvanic current by a zero resistance current method.

In some embodiments, the evaluation method also comprises a step of considering the total time from measuring the galvanic current to measuring the occurrence of the galvanic corrosion as an indicator for evaluating the galvanic corrosion.

Compared with the prior art, the present disclosure has the following beneficial effects:

(1) No measuring method for galvanic corrosion of a conductive coating is provided in existing standards, and measurement with reference to standards has limitations and cannot reflect the protective effect of the conductive coating on the substrate in the corrosive medium. The sample used in the present disclosure is that a micropore insulating material is located between the substrate and the conductive coating and plays a good insulating role between the substrate and the conductive coating before the corrosive medium penetrates the conductive coating; and the corrosive medium can rapidly reach the substrate through the micropore insulating material after penetrating the conductive coating, forming an ion pathway. Relevant parameters of galvanic corrosion can be measured, and relevant parameters, such as start time of galvanic corrosion, and galvanic voltage change between the conductive coating and the metal substrate before occurrence of galvanic corrosion, during the process that the corrosive medium penetrates the metal substrate from the surface of the conductive coating can be evaluated.

(2) Galvanic corrosion between the conductive coating and all other (conductive) materials (i.e., substrate) can be measured when the accuracy of the measuring equipment allows, for example, a metal, a metal plating/coating, other conductive coatings and a carbon fiber material.

In order to better understand the present disclosure, the following embodiments are to further describe the present disclosure, but the contents of the present disclosure are not only limited to the following embodiments.

### EMBODIMENTS

### Embodiment 1

### (1) Sample and Preparation Thereof

\textcircled{1} The recommended sample size is 110 mm×25 mm×(2-3) mm, and for special needs, other sizes such as φ25 mm×110 mm can be used. Conductive substrates having a certain mechanical strength can be directly machined, for example, metals and alloys thereof, and carbon fiber composite materials; and conductive materials that do not have the required mechanical strength or need a substrate can be obtained by machining a substrate (an insulating material in case of no special requirements) with an appropriate size according to actual conditions and preparing a corresponding conductive material such as a metal plating and coating, an inorganic membrane of a metal substrate and conductive paint. The surface of the sample is treated according to the pretreatment requirements of the conductive paint or actual conditions. A copper wire is drawn by means of welding or mechanical fixation at one end of the sample, and the contact between the wire and the substrate is ensured to be stable and reliable.

\textcircled{2} A uniform ceramic coating is prepared on the surface of the substrate, and shall be as thin as possible on the premise of guaranteeing insulativity and water permeability to minimize experimental errors.

\textcircled{3} The surface of the ceramic coating is treated according to pre-construction treatment requirements of the conductive paint, and coated with conductive paint according to the construction technology. After the conductive paint is cured completely, a copper wire is drawn by means of mechanical fixation from the surface (at one end close to the copper wire of the substrate), and the contact between the wire and the conductive coating is ensured to be stable and reliable.

Three groups of samples are prepared according to the sample preparation method, and a copper wire is drawn from the surface of a silver conductive coating.

\textcircled{4} The test area is generally 25 cm². After the test area is determined, the surface of the conductive coating is coated with an insulating protective layer by means of ceresin wax immersion or other coating sealing methods to seal the sample.

\textcircled{5} After the sample preparation is completed, the surface shall be cleaned with alcohol or other suitable means as necessary, and the surface of the sample shall be kept clean before the end of the test.

\textcircled{6} The test area is measured accurately with a vernier caliper or a micrometer.

(2) Test instrument and device connection

\textcircled{1} Test solution: the electrolyte can be natural seawater, 3.5% NaCl solution. artificial seawater, etc. as needed, and the ratio of the volume of the test solution to the test area is not less than 20 mL/cm².

\textcircled{2} Galvanic current is measured by the zero resistance technology, the instrument can be a zero resistance ammeter, a galvanic corrosion measuring instrument, a constant potential rectifier which can be connected with a zero resistance circuit, or an electrochemical workstation, and auxiliary instruments comprise a thermostatic waterbath device, a beaker, a saturated calomel electrode, etc.

\textcircled{3} At least three groups of galvanic corrosion samples shall be set, and at least three groups of uncoupled contrast samples shall be set.

(3) Measurement

\textcircled{1} After the sample is placed in the solution, the circuit shall be energized immediately, galvanic current is measured, and the measurement time is recorded.

\textcircled{2} The galvanic potential of the coupled samples and the electrode potential of the uncoupled contrast samples are measured simultaneously, for example, 1 h, 4 h, 8 h and 24 h, and then every morning and afternoon.

(4) Evaluation \textcircled{1} A galvanic current-time curve is drawn, from which the speed of galvanic corrosion at a certain moment can be known.

\textcircled{2} The time when galvanic corrosion current appears (not 0) is recorded.

\textcircled{3} The average galvanic current density is calculated according to the galvanic current, the test area and the time.

\textcircled{4} The appearance of the coating after the end of the test is observed.

\textcircled{5} Galvanic corrosion is evaluated in combination with the polarity of components, open circuit potential difference, cathode and anode polarization, etc.

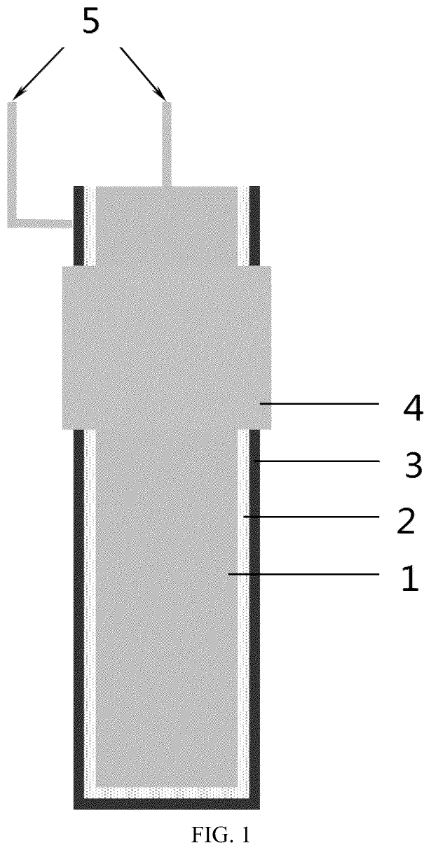

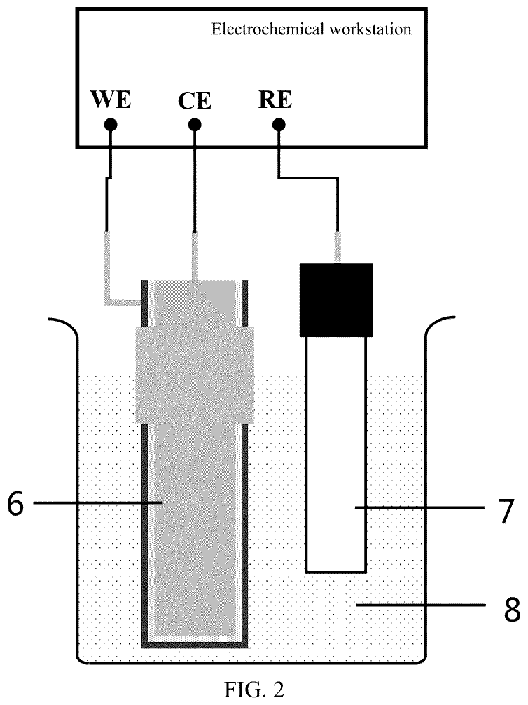

In the present embodiment, tabular 2A12 aluminum alloy with the size of 100 mm×50 mm×1 mm is selected as the substrate, at one end of which a copper wire is drawn by means of tin soldering. According to the preparation process of thermal spraying zirconia ceramics, that is to use plasma spraying equipment (type GTV F6) to prepare an insulating coating by spraying, powder is heated to melt and then sprayed onto the surface of the 2A12 aluminum alloy substrate by high speed airflow atomization, and a porous ceramic coating with penetrating through holes is obtained by process control; the measured thickness of the coating is 56.3 μm, and the measured resistivity between the ceramic coating and the 2A12 aluminum alloy substrate is 5.8×10¹¹ Ω·m; after artificial seawater is dripped on the surface, the, dramatic decline of the resistivity can be measured after about 2-5 s, which confirms that the artificial seawater has penetrated from the ceramic coating to the aluminum plate. In the present embodiment, artificial seawater is used as the corrosive medium, and the formulation of the artificial seawater is shown in GB/T 15748-2013 The method of galvanic corrosion test for metallic ship materials. The measured resistivity of the artificial seawater is 4.7 Ω·m, and the measured resistivity between the artificial seawater and the ceramic coating with one side fully wetted by the artificial seawater is 4.8 Ω·m. 2A12 aluminum alloy with the surface coated with a zirconia porous ceramic coating (the thickness of which is still 56.3 μm) is prepared in parallel according to the same technology, a silver conductive coating is sprayed onto the 2A12 aluminum alloy surface, the thickness of the coating is 83.6 μm, and the measured resistivity between the silver conductive coating and 2A12 is 6.3×10¹¹ Ω·m. The sample preparation meets the requirements. The test area is selected as 50 cm², an insulating coating is prepared from fluorocarbon paint according to the test area to seal the sample, and after sealing, the test area accurately measured with a vernier caliper is 50.26 cm². The structure of the sample obtained is shown in FIG. 1. The surface of the conductive coating is cleaned with a cleaning agent as necessary. 1500 mL of artificial seawater is filled in a beaker, the sample and the reference electrode are immersed into the artificial seawater, the liquid level is kept in the intermediate position of the insulating coating of the sample (the part above the liquid level is kept dry), the test circuit, is connected according to the test requirements, as shown in FIG. 2, the circuit is energized immediately, galvanic current is measured, and the measurement time is recorded. Three groups of parallel samples are set.

TABLE 1
Measured galvanic current of sample to be tested in embodiment 1 at different times

| Time | | 1 h | 2 h | 4 h | 6 h | 8 h | 10 h | 12 h | 16 h | 24 h | 32 h | 48 h |
|---|---|---|---|---|---|---|---|---|---|---|---|---|
| Galvanic | 1# | 0 | 0 | 0 | 0 | 2261.5 | 1321.6 | 938.7 | 883.9 | 764.4 | 761.5 | 775.8 |
| current | 2# | 0 | 0 | 0 | 0 | 0 | 1234.8 | 958.4 | 869.8 | 789.2 | 746.9 | 758.1 |
| (μA) | 3# | 0 | 0 | 0 | 0 | 2078.3 | 1268.5 | 929.6 | 871.4 | 818.4 | 796.3 | 765.9 |

Evaluation of test results: based on three groups of parallel tests, for silver conductive paint, obvious corrosion current can be measured within 8-10 h in the artificial seawater, indicating that the silver conductive paint can protect the substrate well before 6 h, after 6 h, the artificial seawater may have slowly penetrated the conductive coating and have reached the substrate through the insulating porous material, so corrosion current can be measured for the three groups of samples at measurement points of 8 h and 10 h, and the corrosion current is not 0, indicating that galvanic corrosion has occurred between the conductive coating and the substrate 2A12. It can be known according to the direction of corrosion current that the silver conductive coating is a cathode and 2A12 is an anode.

### Embodiment 2

In the present embodiment, tabular 921A steel alloy with the size of 100 mm×50 mm×1 mm is selected as the substrate, at one end of which a copper wire is drawn by means of tin soldering. According to the preparation process of thermal spraying alumina ceramics, that is to use plasma spraying equipment (type GTV F6) to prepare an insulating coating by spraying, powder is heated to melt and then sprayed onto the surface of the 921A aluminum alloy substrate by high speed airflow atomization, and a porous ceramic coating with penetrating through holes is obtained by process control

The measured thickness of the coating is 62.7 μm, and the measured resistivity between the ceramic coating and the 921A steel alloy substrate is 6.7×10¹¹ Ω·m; after artificial seawater is dripped on the surface, the dramatic decline of the resistivity can be measured after about 2-5 s, which confirms that the artificial seawater has penetrated from the ceramic coating to the steel plate. In the present embodiment, artificial seawater is used as the corrosive medium, and the formulation of the artificial seawater is shown in GB/T 15748-2013 The method of galvanic corrosion test for metallic ship materials. The measured resistivity of the artificial seawater is 4.6 Ω·m, and the measured resistivity between the artificial seawater and the ceramic coating with one side fully wetted by the artificial seawater is 4,.7 Ω·m. 921A steel alloy with the surface coated with an alumina porous ceramic coating (the thickness of which is still 62.7 μm) is prepared in parallel according to the same technology, a copper conductive coating is sprayed onto the 921A steel alloy surface, the thickness of the coating is 72.8 μm, and the measured resistivity between the copper conductive coating and 921A is 6.9×10¹¹ Ω·m.

The sample preparation meets the requirements. The test area is selected as 50 cm², an insulating coating is prepared from fluorocarbon paint according to the test area to seal the sample, and after sealing, the test area accurately measured with a vernier caliper is 50.32 cm². The structure of the sample obtained is shown in FIG. 1. The surface of the conductive coating is cleaned with a cleaning agent as necessary. 1500 mL of artificial seawater is filled in a beaker, the sample and the reference electrode are immersed into the artificial seawater, the liquid level is kept in the intermediate position of the insulating coating of the sample (the part above the liquid level is kept dry), the test circuit is connected according to the test requirements, as shown in FIG. 2, the circuit is energized immediately, galvanic current is measured, and the measurement time is recorded. Three groups of parallel samples are set.

Other samples and preparations thereof, test instrument and device connection, measurement and evaluation are the same as those in embodiment 1.

Experimental results are as follows:

TABLE 2

| | | Time | | | | | | | | | | | | | | | | |
|---|---|---|---|---|---|---|---|---|---|---|---|---|---|---|---|---|---|---|
| | | 1 h | 2 h | 4 h | 6 h | 8 h | 10 h | 12 h | 16 h | 24 h | 32 h | 48 h | 56 h | 64 h | 72 h | 80 h | 86 h | 96 h |
| | | 1 h | 2 h | 4 h | 6 h | 8 h | 10 h | 12 h | 16 h | 24 h | 32 h | 48 h | 56 h | 64 h | 72 h | 80 h | 86 h | 96 h |
| Galvanic | 1# | 0 | 0 | 0 | 0 | 0 | 0 | 0 | 0 | 0 | 301.9 | 296.5 | 292.5 | 289.5 | 286.3 | 288.6 | 291.5 | 285.7 |
| current | 1# | 0 | 0 | 0 | 0 | 0 | 0 | 0 | 0 | 0 | 301.9 | 296.5 | 292.5 | 289.5 | 286.3 | 288.6 | 291.5 | 285.7 |
| (μA) | 2# | 0 | 0 | 0 | 0 | 0 | 0 | 0 | 0 | 0 | 312.6 | 290.1 | 294.3 | 296.1 | 276.8 | 282.4 | 289.3 | 284.9 |
| | 2# | 0 | 0 | 0 | 0 | 0 | 0 | 0 | 0 | 0 | 312.6 | 290.1 | | | | 282.4 | 289.3 | 284.9 |
| | 3# | 0 | 0 | 0 | 0 | 0 | 0 | 0 | 0 | 0 | 316.8 | 289.6 | 286.9 | 282.3 | 283.2 | 286.5 | 283.6 | 281.3 |

Evaluation of test results: based on three groups of parallel tests, for copper conductive paint, obvious corrosion current can be measured within 32 h in the artificial seawater, indicating that the copper conductive paint can protect the<substrate well before 24 h; after 24 h, the artificial seawater may have slowly penetrated the conductive coating and have reached the substrate through the insulating porous material, so corrosion current can be measured for the three groups of samples at a measurement point of 32 h, and the corrosion current is not 0, indicating that galvanic corrosion has occurred between the conductive coating and the substrate 921A. It can be known according to the direction of corrosion current that the copper conductive coating is a cathode and 921A is an anode.

The above descriptions are only preferred embodiments of the present disclosure and are not intended to limit the protection scope of the present disclosure. It should be noted that, for those ordinary skilled in the art, several improvements and variations may be made without departing from the principles of the present disclosure, and these improvements and variations should also be considered to be within the protection scope of the present disclosure.

### INDUSTRIAL APPLICABILITY

The present disclosure provides a sample and an evaluation method for measuring galvanic corrosion between a conductive coating and a protected substrate. The sample used in the present disclosure is that a micropore insulating material is located between the substrate and the conductive coating and plays a good insulating role between the substrate and the conductive coating before the corrosive medium penetrates the conductive coating; and the corrosive medium can rapidly reach the substrate through the micropore insulating material after penetrating the conductive coating, forming an ion pathway. Relevant parameters of galvanic corrosion can be measured, and relevant parameters, such as start time of galvanic corrosion, and galvanic voltage change between the conductive coating and the metal substrate before occurrence of galvanic corrosion, during the process that the corrosive medium penetrates the metal substrate from the surface of the conductive coating can be evaluated, having a wide range of application values.

The present disclosure can measure galvanic corrosion between the conductive coating and all other (conductive) materials (i.e., substrate) when the accuracy of the measuring equipment allows, for example, a metal, a metal plating/coating, other conductive coatings and a carbon fiber material, having a wide application range and a good application prospect.

1. A sample for measuring galvanic corrosion between a conductive coating and a substrate, wherein the test part of the sample is composed of a substrate to be tested, a conductive coating to be tested and a micropore insulating layer, the micropore insulating layer is located between the substrate and the conductive coating and can form an ion pathway on the surfaces of the conductive coating and the substrate after being filled with a conductive medium, and the substrate and the conductive coating are both connected with an independent leading wire.

2. The sample for measuring galvanic corrosion between a conductive coating and a substrate according to claim 1, wherein, the substrate is selected from substrates that easily produce or are capable of producing electrochemical corrosion when in contact with the conductive material and in an electrolyte together with the conductive material; and/or
the substrate is selected from substrates that cause the conductive material to easily produce or be capable of producing electrochemical corrosion when in contact with the conductive material and in an electrolyte together with the conductive material; and/or
the substrate is selected from substrates that easily produce or are capable of producing current between the substrates and the conductive material when in contact with the conductive material and in an electrolyte together with the conductive material; and/or
the substrate is selected from substrates that are easily corroded in an electrolyte; and/or
the substrate is selected from substrates with electrical conductivity.

3. The sample for measuring galvanic corrosion between a conductive coating and a substrate according to claim 1, wherein
the substrate comprises a material body or a material coating; and the material body or the material coating is selected from but not limited to: a conductor, a semiconductor and a conductive material;
preferably, the conductor includes: a metal, graphite and a carbon conductor material;
preferably, the semiconductor includes: a silicon-containing material, a germanium-containing material, a gallium-containing material, a selenium-containing material, a manganese oxide, a chromium oxide, an iron oxide and a copper oxide.

4. The sample for measuring galvanic corrosion between a conductive coating and a substrate according to claim 1, wherein the substrate includes a metal, a metal plating/coating, a conductive coating and a carbon fiber material.

5. The sample for measuring galvanic corrosion, between a conductive coating and a substrate according to claim 1, wherein the surface of the sample except the test part is coated with an insulating protective layer.

6. The sample for measuring galvanic corrosion between a conductive coating and a substrate according to claim 1, wherein the resistivity between the substrate and the micropore insulating layer is more than 1×10¹¹ Ω·m; and the resistivity between the conductive coating and the micropore insulating layer is more than 1×10¹¹ Ω·m.

7. The sample for measuring galvanic corrosion between a conductive coating and a substrate according to claim 1, wherein after the micropore structure of the micropore insulating layer is filled with a conductive medium, the difference between the resistivity of the micropore insulating layer and the resistivity of the conductive medium itself is not more than 5%.

8. The sample for measuring galvanic corrosion between a conductive coating and a substrate according to claim 1, wherein the pore structure of the micropore structure makes the time required for the corrosive medium to conduct from one side of the micropore insulating layer to the other side not more than 180 s.

9. The sample for measuring galvanic corrosion between a conductive coating and a substrate according to claim 1, wherein the thickness of the micropore insulating layer is not more than 20 μm.

10. The sample for measuring galvanic corrosion between a conductive coating and a substrate according to claim 1, wherein the micropore insulating layer is a porous ceramic coating.

11. An electrochemical device for measuring galvanic corrosion between a conductive coating and a substrate, comprising the sample for measuring galvanic corrosion between a conductive coating and a substrate of claim 1.

12. Applications of the sample for measuring galvanic corrosion between a conductive coating and a substrate of claim 1 in evaluating galvanic corrosion of a conductive coating.

13. Applications of the electrochemical device for measuring galvanic corrosion between a conductive coating and a substrate of claim 11 in evaluating galvanic corrosion of a conductive coating.

14. An evaluation method for galvanic corrosion of a conductive coating, wherein the sample of claim 1 is adopted for galvanic corrosion test.

15. The evaluation method according to claim 14, comprising the following steps:
(1) obtaining a sample composed of a conductive coating to be tested, a micropore insulating layer and a substrate;
(2) obtaining a corrosive medium to be tested;
(3) immersing the test part of the sample into the corrosive medium, and preventing the substrate from being in contact with the corrosive medium;
(4) selecting a reference electrode as required, connecting a circuit and measuring instruments, and measuring galvanic current by a zero resistance current method.

16. The evaluation method according to claim 14, further comprising a step of considering the total time from measuring the galvanic current to measuring the occurrence of the galvanic corrosion as an indicator for evaluating the galvanic corrosion.
